(19) United States
(12) Patent Application Publication
(10) Pub. No.: US 2003/0232898 A1
(43) Pub. Date: Dec. 18, 2003

(54) Ultra flexible pipe insulation

(75) Inventors: Emanuel Jozeph Herman Marie Van Der Ven, Waalwijk (NL); Hendrik Willem Bout, Waalwijk (NL); Humphrey Reginald de Bell, Waalwijk (NL); Gerrit-Jan Baars, Waalwijk (NL)

Correspondence Address: LADAS & PARRY, 26 WEST 61ST STREET, NEW YORK, NY, 10023, US

(73) Assignee: THERMAFLEX INTERNATIONAL HOLDING B.V.

(21) Appl. No.: 10/439,279

(22) Filed: May 15, 2003

Related U.S. Application Data
(63) Continuation of application No. PCT/NL00/00859, filed on Nov. 23, 2000.

(51) Int. Cl. C08F 2/00

(52) U.S. Cl. 521/142; 138/149

(57) ABSTRACT

The present invention relates to pipe insulation made from a polyolefin thermal insulation foam which is made by extruding, using a physical blowing agent, a foam composition comprising 77-99% by weight of a metallocene polyethylene, 5-18% by weight of a flame extinguisher, 3-8% by weight of a cell stabilizer and 0-5% by weight of other usual foam additives. The invention further relates to a method for preparing a physically foamed polyolefin thermal insulation foam and to the foam prepared therewith. The foam is very flexible and as a result the pipe insulation is particularly suitable for the thermal insulation of pipes for split air conditioning, district heating, solar energy exploitation and the process industry, even when it regards thin and/or twisting pipes. The pipe insulation can be recycled well.

The present invention relates to a pipe insulation made from a polyolefin thermal insulation foam, to a polyolefin thermal insulation foam and to a method for preparing a physically foamed polyolefin thermal insulation foam and to the foam prepared therewith.

For the thermal insulation of pipes such as hot water conduits, high and low pressure steam pipes, and pipes for split-air conditioning, district heating, solar energy exploitation and the process industry, hollow profiles having a wall of synthetic foam are used on a large scale. Said profiles will hereinafter be referred to as pipe insulation.

The most important types of pipe insulation that are currently commercially available are PE pipe insulation and rubber pipe insulation.

PE pipe insulation consists of foam that composed of thermoplasts and has a density of approximately 35 kg/m³. This type of foam is usually produced using physical blowing agents (for instance butane) and is not crosslinked. This type of foam has good product properties such as insulation value, fire behaviour and water absorption capacity. The foam can be recycled excellently. The foam is prepared in a single process, i.e. the production takes place on one step. A drawback of PE pipe insulation material is that it is less flexible than rubber pipe insulation as a result of which it is difficult to apply around thin and twisting pipes. As a result the material is not suitable for some uses such as for instance air conditioning and cooling.

Rubber pipe insulation consists of foam that is composed of elastomers and has a density of about 60 kg/m³. This type of foam is often produced using chemical blowing agents (for instance azo-compounds) and usually is crosslinked. Rubber pipe insulation is a very flexible material that is easy to apply. This type of foam has good product properties such as insulation value and fire behaviour. A drawback of rubber pipe insulation is that it cannot be recycled and that it is relatively heavy (that means that a lot of material is necessary for insulation). The water absorption capacity is good as such, but in case of damage to its skin the material behaves like a sponge and said good property is lost. Another drawback of rubber pipe insulation is that this material is produced using a method comprising three steps: kneading, extruding and foaming. In combination with the high density this makes the cost price of rubber pipe insulation higher than that of PE pipe insulation.

U.S. Pat. No. 6,054,078 discloses a process for manufacturing an integrally bonded, multilayered foamed product comprising first extruding, using a physical blowing agent, a foamed core member, cooling said core member, heating the surface of the core member to a temperature approaching the melting point of the core member and applying a molten plastic coating to the heated surface of the core member to peripherally surround the core member. The core member may comprise a metallocene polymer, and additives such as a flame extinguisher and a cell stablizer.

There is a need for an ultra flexible pipe insulation that is easy to apply around twisting pipes, has excellent thermal insulation capacity, is made from foam that can be recycled well and has a low density of preferably 35 kg/m³ or less.

It was found that that need can be met by a pipe insulation consisting of one layer of a polyolefin foam that only comprises metallocene polyethylene as polyolefin.

The present invention provides a polyolefin thermal insulation foam which is made by extruding, using a physical blowing agent, a foam composition comprising a metallocene polyethylene, a flame extinguisher and a cell stabilizer, characterised in that said composition comprises 77-92% by weight of metallocene polyethylene, 5-10% by weight of a flame extinguisher, optionally a stabilizer and/or catalyst for the flame extinguisher, the total amount of said flame extinguisher, said optional catalyst and said optional stabilizer being 5-18% by weight, 3-8% by weight of a cell stabiliser and 0-5% by weight of other usual foam additives.

The foam preferably has a density of less than 35 kg/M³, particularly less than 30 kg/m³.

The degree of flexibility of the foam can be indicated by the indentation strength according to DIN 53577. Preferably it is 0.020 N/mm² or less at 10% indentation, 0.035 N/mm² at 20% indentation, and 0.100 N/mm² at 50% indentation.

Due to the high flexibility of the foam, pipe insulation made from the foam according to the invention is easily applied around twisting pipes. Because the foam is prepared using physical blowing agents and is not chemically crosslinked, it can be recycled easily.

The term “metallocene polyethylene” refers to polyethylenes that are prepared by polymerising ethylene in the presence of a metallocene catalyst. For preparing and processing metallocene polyethylene reference is made to for instance Kurt W. Schwogger, An outlook for metallocene and single site catalyst technology into the 21^{st} century, Antec 98, Processing Metallocene Polyolefines, Conference Proceedings, October 1999, Rapra Technology, and Proceedings of 2^{nd} International Congress on Metallocene Polymers, Scotland Conference Proceedings, March 1998.

A suitable polyolefin for the preparation of polyolefin foam according to the invention is for instance a polyolefin elastomer having a density of 880-920 kg/m³, a melt flow index (MFI) of between 0.5 and 4.5 g/10 min at 190° C., a DSC-melting peak of between 98 and 107° C. and a tensile strength (ASTM D-683M-90, 50 mm/min) of between 20 and 60 MPa.

The invention further provides a method for preparing a physically foamed polyolefin thermal insulation foam by extruding, using a physical blowing agent, a composition comprising a metallocene polyethylene, a flame extinguisher and a cell stabiliser, characterized in that the process comprises the steps of a) mixing 77-92% by weight of metallocene polyethylene, 5-10% by weight of flame extinguisher, optionally a stabilizer and/or catalyst for the flame extinguisher, the total amount of said flame extinguisher, said optional catalyst and said optional stasbilizer being 5-18% by weight, and 0-5% by weight of foam additives in an extruder to obtain a mixture b) adding 3-8% by weight of a cell stabiliser to said mixture, c) melting said mixture in the melting zones of the extruder adjusted to temperatures of 180 to 240° C., at a pressure increasing from 1 bar up to 400 bar, d) injecting a physical blowing agent at an injection temperature of 140 to 180° C. and an injection pressure of 200 to 300 bar, e) cooling the molten mixture in cooling zones of the extruder adjusted to temperatures of 60 to 110° C. and f) extruding the mixture through an extrusion nozzle adjusted to a temperature of 85 to 110° C., so that the mixture expands to a foam at a pressure of 1 atm.

Any flame extinguisher normally used in the art can be used as flame extinguisher provided that it does not affect the properties of the foam. Examples of flame extinguishers for use in the invention include halogen containing flame extinguishers. Halogen containing flame extinguishers are usually used in combination with a stabilizer such as pentaerythritol and a catalyst such as for instance antimony trioxide. The mixing ratio between antimony trioxide and the halogen containing component may for instance be about 1:3 or 1:2. It is also possible to use various flame extinguishers. The total added quantity of flame extinguisher including optional stabilizer and catalyst is approximately 5-18% by weight, based on the total quantity of polymer and additives. When the flame extinguisher is used in a quantity of less than 5% by weight, the fire resistant properties of the foam may be insufficient. The use of a quantity of flame extinguisher of more than 10% may result in affecting the properties of the foam (flexibility).

The cell stabilizer prevents the blowing agent from escaping from the polymer melt immediately after injection, as a result of which no foam is formed. Any cell stabilizer normally used in the art can be used as cell stabilizer, provided that it does not affect the properties of the foam. Examples of suitable cell stabilizers include cell stabilizers of the type stearic acid amide, glycol monostearate and fatty acids of glycine. It is also possible to use more than one cell stabilizer. The total added quantity of cell stabilizer is about 3-8% by weight, based on the total quantity of polymer and additives. The cell stabilizer is suitably added by means of for instance a side feeder, to the mixture of polymer, flame extinguisher and optional other additives before the mixture is melted on.

In addition to the flame extinguisher and the cell stabilizers the usual additives for polyolefin foams can be added to the foam. Non-limiting examples of them include colorants, pigments, fillers, nucleating agents and stabilizers.

As blowing agent any substance can be used that is liquid at high pressure, particularly the pressure prevailing in the extruder used for carrying out the method, but which substance evaporates at lower pressure. Non-limiting examples of the blowing agent comprise alkanes having 3 to 8 carbon atoms, such as for instance propane, butane, isobutane and hexane. The blowing agent is brought to a temperature of 140 to 180° C. and a pressure of 200 to 300 bar and continuously injected into the melted mixture in the extruder.

It is important that when mixing the metallocene polyethylene, the flame extinguisher and the optional additives, the mixture is melted well in the extruder, i.e. the polymer is brought in the liquid phase resulting in such a viscoelastic behaviour that polymer and additives are mixed well into each other and that in a later stage also the physical blowing agent is incorporated well into the polymer mixture. When for the preparation of the polyolefin foam according to the invention a mixer is used in which only low shearing forces are exerted on the mixture, it is advantageous to choose such a temperature that the viscoelastic behaviour of the polymer and additives is almost equal. A parameter to express viscous behaviour is the melt flow index (MFI) (the throughput of material at a certain temperature and pressure). With the present method the MFI-values of polymers and additives are suitably between 0.5 and 4.5 g/10 minutes at 190° C.

The method of the invention can suitably be carried out on a single screw extruder having an L/D between 30 and 60, provided with mixing parts and a static mixer having for instance a throughput of 50 to 150 kg/h.

The pipe insulation material according to the invention suitably has a wall thickness of 3 to 30 mm at an inner diameter of 4-130.

### EXAMPLE

A single screw extruder of the type described above was provided with an open space of 5-100 mm², after which the number of revolutions was adjusted at 15-40 rpm.

A mixture of polymer and additives (flame extinguisher, cell stabilizers) was added in the above-mentioned mixing ratios. The melting zones of the extruder were adjusted at 200-240° C., the cooling zones were adjusted at 60-95° C. Blowing agent (propellant) was injected at an injection pressure of 200-250 bar and a mass temperature of 80 to 105° C. in a quantity of 20-25 l/h (as liquid). The pressure in the extruder decreased to approximately 10-30 bar at the nozzle of the extruder, after which the mixture expanded to a foam having a density of 20 to 25 kg/m³ in the form of pipe insulation having an internal diameter of 18-28 mm and a wall thickness of 20-30 mm.

The pipe insulation material according to the invention had the following properties.

| Properties | |
|---|---|
| Density (kg/m³, volumetrically determined) | 15-30 |
| Cross-section cells (mm) | 0.30-0.50 |
| Insulation value (λ₄₀, W/m.K) | 0.035-0.040 |
| Flexibility¹) (indentation strength in N/mm²⁾ | |
| 10% indentation | 0.012-0.020 |
| 20% indentation | 0.018-0.026 |
| 50% indentation | 0.076-0.096 |
| Rebound after 70% indentation, t = 0 hour | 90-95 |
| (internal method) | |
| Rebound after 70% indentation, t = 1 hour | 95-100 |
| (internal method) | |

¹)The flexibility was measured according to DIN 53577.

1. A polyolefin thermal insulation foam which is made by extruding, using a physical blowing agent, a foam composition comprising a metallocene polyethylene, a flame extinguisher and a cell stabilizer, characterised in that said composition comprises 77-92% by weight of metallocene polyethylene, 5-10% by weight of flame extinguisher, optionally a stabilizer and/or catalyst for the flame extinguisher, the total amount of said flame extinguisher, said optional catalyst and said optional stabilizer being 5-18% by weight, 3-8% by weight of cell stabilizer and 0-5% by weight of other usual foam additives.

2. A polyolefin thermal insulation foam according to claim 1 having a density of no more than 35 kg/m³.

3. A polyolefin thermal insulation foam according to claim 1 having a density of no more than 30 kg/m³.

4. A polyolefin thermal insulation foam according to claim 1, 2 or 3, having an indentation strength measured according to DIN 53577 of:
≦0.020 N/mm² at 10% indentation,
≦0.035 N/mm² at 20% indentation, and
≦0.100 N/mm² at 50% indentation.

5. A pipe insulation made from a polyolefine thermal insulation foam according to any one of claims 1-4.

6. A method for preparing a physically foamed polyolefin thermal insulation foam by extruding, using a physical blowing agent, a composition comprising a metallocene polyethylene, a flame extinguisher and a cell stabiliser, characterized in that the process comprises the steps of a) mixing 77-92% by weight of metallocene polyethylene, 5-10% by weight of a flame extinguisher, optionally a stabilizer and/or catalyst for the flame extinguisher, the total amount of said flame extinguisher, said optional catalyst and said optional stabilizer being 5-18% by weight, and 0-5% by weight of foam additives in an extruder to obtain a mixture, b) adding 3-8% by weight of a cell stabilizer to said mixture, c) melting said mixture in the melting zones of the extruder adjusted to temperatures of 180 to 240° C., at a pressure increasing from 1 bar up to 400 bar, d) injecting a physical blowing agent at an injection temperature of 140 to 180° C. and an injection pressure of 200 to 300 bar, e) cooling the molten mixture in cooling zones of the extruder adjusted to temperatures of 60 to 110° C., and f) extruding the mixture through an extrusion nozzle adjusted to a temperature of 85 to 110° C., so that the mixture expands to a foam at a pressure of 1 atm.

7. A method according to claim 6, wherein the foam produced has a density of no more than 35 kg/m.

8. A method according to claim 6, wherein the foam produced has a density of no more than 30 kg/m³.

9. A method according to claim 6, wherein the foam produced has an indentation strength measured according to DIN 53577 of
≦0.020 N/mm² at 10% indentation,
≦0.035 N/mm² at 20% indentation, and
≦0.100 N/mm² at 50% indentation.

10. A method according to any one of claims 6-9 wherein the mixture expands to a foam in the form of a pipe insulation.
